(19) United States
(12) Patent Application Publication
(10) Pub. No.: US 2017/0350467 A1
(43) Pub. Date: Dec. 7, 2017

(54) DAMPER

(71) Applicant: SUSPA GmbH, Altdorf (DE)

(72) Inventors: Andreas BÖHRER, Neumarkt (DE); Florian STEPHAN, Herzogenaurach (DE)

(21) Appl. No.: 15/608,049

(22) Filed: May 30, 2017

(30) Foreign Application Priority Data
Jun. 3, 2016 (DE) 10 2016 209 826.8

(51) Int. Cl. F16F 9/44; F16F 9/46; F16F 9/06

(52) U.S. Cl. CPC F16F 9/44; F16F 9/468; F16F 9/062

(57) ABSTRACT

A damper comprises a housing having a working chamber; damping fluid located in the working chamber; a piston unit arranged in the working chamber, having a piston rod having a longitudinal axis, a piston fastened to the piston rod, said piston subdividing the working chamber into a first working chamber part and into a second working chamber part, a through-flow duct connecting the first working chamber part and the second working chamber part; an adjusting unit for adjusting the damping force of the damper, having an adjusting element for adjusting the effective flow cross-sectional area of the through-flow duct, an adjusting actuator for automatically adjusting an arrangement of the adjusting element and of the piston rod, a force transmission device for transmitting an actuating force provided by the adjusting actuator, wherein the adjusting actuator is arranged outside the housing.

### CROSS-REFERENCE TO RELATED APPLICATIONS

This application claims priority of German Patent Application Serial No. 10 2016 209 826.8 filed Jun. 3, 2016, pursuant to 35 U.S.C. 119(a)-(d), the content of which is incorporated herein by reference in its entirety as if fully set forth herein.

### FIELD OF THE INVENTION

The invention relates to a damper.

### BACKGROUND OF THE INVENTION

A damper is known from DE 10 2010 029 180 A1.

### SUMMARY OF THE INVENTION

An object of the present invention is to develop a damper such that the settability of a damping action of the damper is improved.

This object is achieved according to the invention by a damper comprising a housing having a working chamber; damping fluid located in the working chamber; a piston unit arranged in the working chamber, having a piston rod having a longitudinal axis, a piston fastened to the piston rod, said piston subdividing the working chamber into a first working chamber part and into a second working chamber part, a through-flow duct connecting the first working chamber part and the second working chamber part; an adjusting unit for adjusting the damping force of the damper, having an adjusting element for adjusting the effective flow cross-sectional area of the through-flow duct, an adjusting actuator for automatically adjusting an arrangement of the adjusting element and of the piston rod, a force transmission device for transmitting an actuating force provided by the adjusting actuator, wherein the adjusting actuator is arranged outside the housing.

According to the invention, it has been found that an adjusting unit for adjusting a damping force of a damper has an adjusting actuator which is arranged outside a housing of the damper. The adjusting unit furthermore has an adjusting element for adjusting the effective flow cross-sectional area of a through-flow duct, and a force transmission device for transmitting an actuating force provided by the adjusting actuator to the adjusting element. By way of the adjusting actuator, an arrangement of the adjusting element and of a piston rod can be adjusted in an automated manner. The piston rod is a constituent part of a piston unit. The piston rod has a longitudinal axis. Fastened to the piston rod is a piston which subdivides a working chamber of the housing, in which damping fluid is located, into a first working chamber part and into a second working chamber part. The through-flow duct connects the first working chamber part to the second. The adjusting element is arranged in particular within the damper, in particular within the damper housing, in particular within the piston rod. The adjusting element can be embodied as a cover which covers or opens up at least some or part of the through-flow openings. The adjusting element can also be embodied as a control rod, cone valve or needle valve. What is essential is that the adjusting actuator is arranged in a manner spatially separated from the adjusting element. The damper itself, in particular the housing, can be embodied in a compact and uncomplicated manner. In particular, already existing dampers, which are embodied without an adjusting actuator, can be retrofitted to form a damper according to the invention. As a result of the functional separation of the adjusting actuator and adjusting element, various drive concepts for the adjusting actuator are possible, in order to provide a required actuating force. For example, electric, hydraulic or pneumatic adjusting actuators are possible. Depending on the embodiment of the adjusting element, the force transmission device allows a suitable transmission of the actuating force into an adjusting movement of the adjusting element. It is possible for example for a spindle drive, a linear motor, an electromagnet, a rotary magnet, a pneumatic cylinder or a hydraulic cylinder to serve as force transmission devices. Outside the housing means that not even some of the adjusting actuator is arranged within the housing. The adjusting actuator is arranged on the damper in particular at a distance from the housing. It is conceivable for the adjusting actuator to be fastened directly to an outer side of the housing or by means of additional fastening elements. The adjusting actuator can also be arranged at a distance from the housing.

A control unit with a control unit which has a signal link to the adjusting unit, for the controlled adjustment of the effective flow cross-sectional area of the through-flow duct, ensures targeted setting of the damping action. The control unit has in particular a signal link to the adjusting unit.

Rotatability of the adjusting element and the piston rod relative to one another about the longitudinal axis allows the damping force to be influenced directly.

The rotatability of the adjusting element, which is in particular drivable in rotation, about the longitudinal axis involves reduced retrofitting effort.

Rotatability of the piston rod, which is in particular drivable in rotation, about the longitudinal axis allows simplified transmission of rotation to the piston rod.

An adjusting lever of the adjusting element, said adjusting lever being oriented transversely, in particular radially, with respect to the longitudinal axis, allows a simplified coupling of the adjusting actuator to the adjusting element via the force transmission device.

Articulation of the force transmission device directly to the adjusting lever allows improved force transmission.

A pivot lever of the force transmission device, said pivot lever being pivotable about a pivot, in particular a pivot fixed to the damper, said pivot lever being connected at a first end to the adjusting actuator and at a second end to the adjusting lever simplifies retrofitting of the damper. In particular, the pivot lever is articulated to the damper in a pivotable manner about a pivot fixed to the damper.

A pulling element, in particular in the form of a Bowden cable, of the force transmission device, said pulling element being in particular a Bowden cable, which connects the pivot lever to the adjusting actuator, allows uncomplicated coupling of the adjusting actuator to the adjusting element. A Bowden cable is a common force transmission means, in particular for transmitting tensile loads. The pulling element, in particular the Bowden cable, is also suitable for transmitting compressive loads. For this purpose, the Bowden cable is embodied with an inner cable which is guided in an outer, comparatively rigid sheath. It is advantageous for the pivot lever to be pivotable in a spring-mounted manner such that, when the pulling element is not transmitting any actuating force, the pivot lever is moved back into an inactivated starting position on account of the spring restoring force.

An adjusting actuator embodied as a rotary drive, in particular as an electric motor, allows uncomplicated and direct provision of the actuating force.

A damper having a toothing, which corresponds to a counterpart toothing on the adjusting element, is embodied in a particularly compact manner.

A damper having a gear wheel, which is arranged in particular directly on the output shaft of the adjusting actuator, is embodied in a particularly robust manner.

A rack on which the counterpart toothing is embodied, said rack being coupled, in particular directly coupled, to the adjusting element, in particular to the adjusting lever, simplifies the retrofitting of the damper. In particular the rack is embodied such that it can interact with an adjusting lever of an adjusting element.

A counterpart gear wheel on which the counterpart toothing is embodied, said counterpart gear wheel being connected to the piston rod for conjoint rotation, wherein in particular the axis of rotation of the counterpart gear wheel is identical to the longitudinal axis of the piston rod, allows the direct force transmission to the piston rod. The piston rod is driven directly by the adjusting element.

Further advantageous configurations, additional features and details of the invention can be gathered from the following description of exemplary embodiments with reference to the drawing.

### BRIEF DESCRIPTION OF THE DRAWING

FIG. 1 shows a perspective illustration of a damper according to a first exemplary embodiment, in which a force transmission device has a Bowden cable,

FIG. 2 shows an enlarged detail illustration of the detail II in FIG. 1,

FIG. 3 shows a longitudinal section on section line III-III in FIG. 1 upon activation in the insertion direction,

FIG. 4 shows a longitudinal section corresponding to FIG. 3 upon activation of the damper in the extension direction,

FIG. 5 shows an enlarged detail illustration, corresponding to FIG. 3, of the lower part of the damper housing according to a further embodiment,

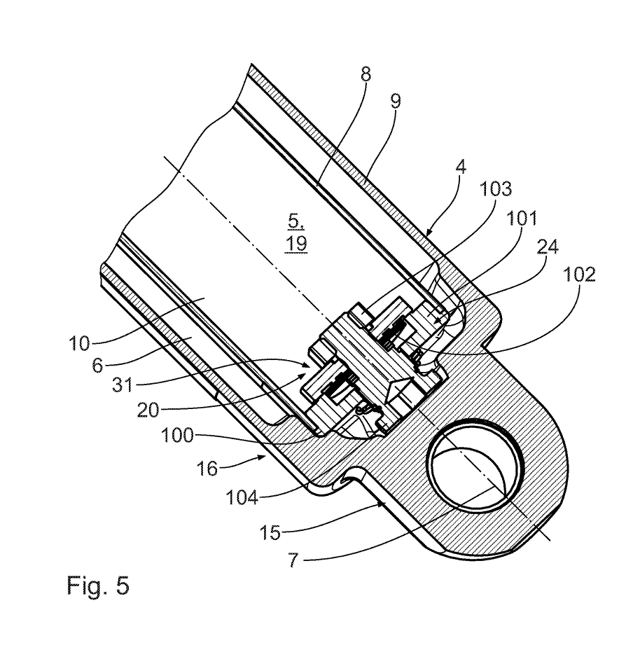

FIG. 6 shows a perspective detail illustration of a damper according to a further exemplary embodiment, in which the force transmission device comprises a gear wheel and a rack,

FIG. 7 shows an illustration, corresponding to FIG. 6, of a damper according to a further exemplary embodiment, in which the force transmission device has a gear wheel and a counterpart gear wheel coupled directly to the adjusting unit,

FIG. 8 shows an enlarged illustration, corresponding to FIG. 2, of a damper according to a further exemplary embodiment, in which the force transmission device comprises a rod-like connecting element,

FIG. 9 shows an illustration, corresponding to FIG. 8, of a damper according to a further exemplary embodiment, in which the force transmission device is articulated directly to the adjusting actuator and to the adjusting unit,

FIG. 10 shows a perspective illustration of a damper according to a further exemplary embodiment, in which the piston rod is drivable in rotation by means of a counterpart gear wheel fastened thereto,

FIG. 11 shows an illustration, corresponding to FIG. 10, of a damper according to a further exemplary embodiment, in which the piston rod is drivable in rotation by means of an eccentric element and a connecting element,

FIG. 12 shows a perspective illustration in partial section of a damper according to a further exemplary embodiment, in which a motor/gear mechanism combination is held on the first fastening element,

FIG. 13 shows an illustration, corresponding to FIG. 12, of a damper according to a further exemplary embodiment, in which the adjusting lever is articulated to the motor/gear mechanism unit by means of a multiple joint hinge.

### DESCRIPTION OF THE PREFERRED EMBODIMENTS

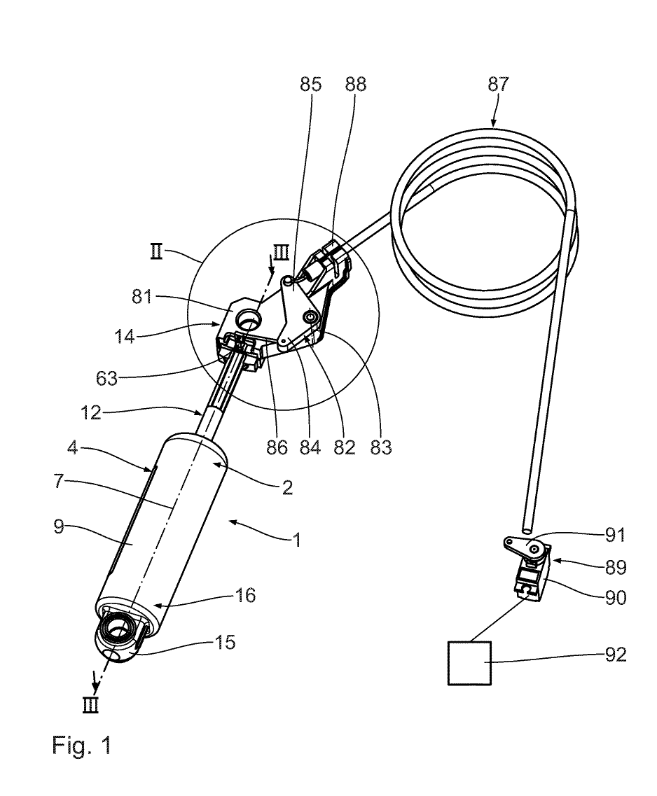

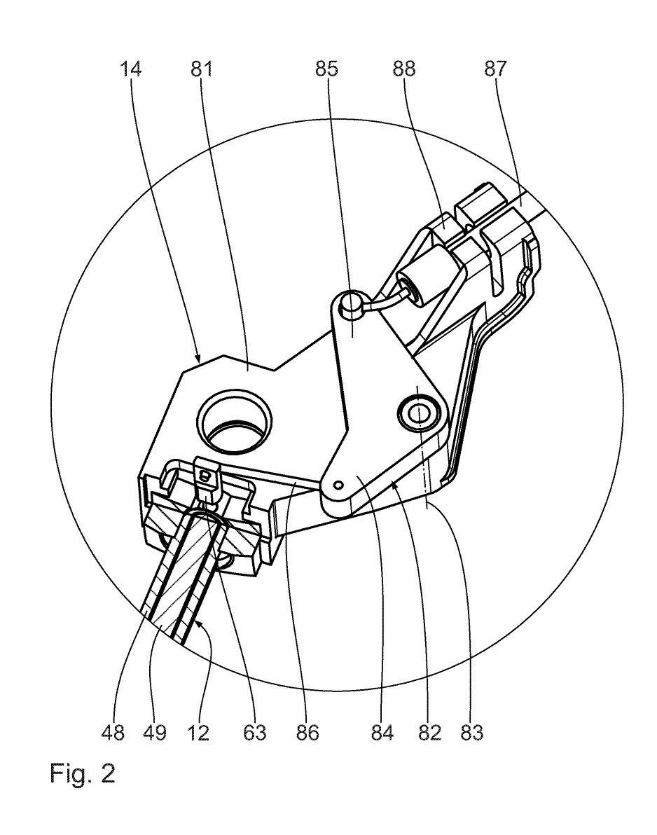

In the following text, a first exemplary embodiment of the invention is described with reference to FIGS. 1 to 4. A damper 1 has a housing 4 with a first housing end 2 and a second housing end 16. The housing 4 is closed at the first housing end 2 by a guiding and sealing unit 3. At the second housing end 16, the housing 4 has a second fastening element 15. The housing 4 encloses a working chamber 5 and a balance chamber 6. The housing 4 has a longitudinal axis 7. It is configured in particular at least partially in a rotationally symmetrical manner with respect to the longitudinal axis 7. The housing 4 can be configured in a double-walled manner. It comprises in particular an inner housing 8 and an outer housing 9. The outer housing 9 surrounds the inner housing 8. The outer housing 9 can be arranged in particular concentrically with the inner housing 8. The balance chamber 6 is thus configured as an annularly cylindrical cavity.

In an alternative variant that is not illustrated in the figures, the outer housing 9 can also be arranged in an offset manner with respect to the inner housing 8, such that the balance chamber 6 has a variable, i.e. non-constant width along its circumference. In this case, the balance chamber 6 can be configured in particular in a topologically contractible manner.

The working chamber 5 is filled with a damping fluid 10. The damping fluid 10 is in particular a hydraulic oil. The balance chamber 6 is partially filled with the damping fluid 10. The rest of the balance chamber 6 is filled with gas, in particular with air.

The guiding and sealing unit 3 comprises a first sealing element 41, which fits closely against the piston rod 12 in a sealed manner. In order to be held on the piston rod 12, the first sealing element 41 has an annular groove 42 in which a clamping ring 43 is arranged. Furthermore, the guiding and sealing unit 3 has a supporting element 44 which is supported towards the outside on the outer housing 9. The supporting element 44 is mounted in a sealed manner against the outer housing 9 by means of a sealing ring 45. It has a central blind hole 46. The guiding and sealing unit 3 has a central bore 47. The bore 47 is arranged in particular concentrically with the longitudinal axis 7. The piston rod 12 is guided through the bore 47.

Furthermore, the damper 1 comprises a piston unit 11 having a piston rod 12 and a piston 13. The piston 13 is fastened to the piston rod 12 and guided in the inner housing 8 so as to be movable along the longitudinal axis 7. The piston rod 12 is guided out of the housing 4 in a manner sealed by the guiding and sealing unit 3. At its opposite end from the piston 13, the piston rod 12 is connected to a first fastening element 14. The first fastening element 14 is embodied in the form of a transverse bore in a mounting plate 81. The mounting plate 81 is firmly connected to the piston rod 12. The mounting plate 81 is arranged in a manner fixed to the damper, in particular to the piston rod.

The piston 13 subdivides the working chamber 5 into a first working chamber part 17 facing the first housing end 2 and having a first working chamber end 18, and a second working chamber part 19 facing the second housing end 16 and having a second working chamber end 20.

Arranged at the first working chamber end 18 is a first terminating element 21. The first terminating element 21 is arranged in the inner housing 8. The first terminating element 21 can in particular be plugged into the inner housing 8, preferably pressed or screwed in. It is sealed off from the inner housing 8 by means of a sealing ring 22. The first terminating element 21 is configured integrally with the supporting element 44. It is thus likewise a constituent part of the guiding and sealing unit 3. In principle, however, it is also conceivable to configure the first terminating element 21 and the supporting element 44 as separate parts.

The first terminating element has a first balance duct 23, which forms a through-flow connection, indicated in the figures by arrows, between the first working chamber part 17 and the balance chamber 6. For further details with regard to the embodiments of the first terminating element 21, reference is made to DE 10 2005 023 756 A1.

Arranged at the second working chamber end 20 is a second terminating element 24. The second terminating element 24 is arranged in the inner housing 8. The second terminating element 24 can in particular be plugged into the inner housing 8, preferably pressed in. The second terminating element 24 can be held in the inner housing 8, in the region of the second working chamber end 20, by an encircling bead 27. In order to improve the hold of the second terminating element 24, the bead 27 can be reinforced by a clamping ring 28. Furthermore, the circumference of the inner housing 8 can regionally rest against the outer housing 9 in the region of the second working chamber end 20, in particular in the region of the bead 27. For this purpose, the outer housing 9 has step-like reinforcements 29, against which a bearing shoulder 30 of the inner housing 8 rests in a form-fitting manner.

The second terminating element 24 can be sealed off from the inner housing 8 by means of a sealing ring 25. It has a second balance duct 26, which forms a through-flow connection between the second working chamber part 19 and the balance chamber 6.

For proper operation of the damper 1, the working chamber 5 should always be completely filled with damping fluid 10. This can be achieved by a suitable configuration and arrangement of the second balance duct 26 and a quantity of damping fluid 10 that is adapted to the volume of the working chamber 5 and the configuration of the balance chamber 6. The damper 1 has in particular a preferred installation position, such that the extension direction 40 is opposed to the direction of the force of gravity. The proper operation of the damper 1 can then be ensured up to a twist angle of at least 77° out of the preferred installation position.

Provided in the second balance duct 26 is a balance valve 31. The balance valve 31 comprises in particular a valve pin 32 which is pretensioned against the second terminating element 24 by means of a conically tapering valve coil spring 33. To this end, the valve coil spring 33 bears against a valve pin stop 34. The valve pin 32 is guided in a bore 35 in the second terminating element 24. The bore 35 is arranged in particular concentrically with the longitudinal axis 7. Furthermore, the balance valve 31 comprises a polygonal valve nut 36 arranged on the valve pin 32. The valve nut 36 forms a further stop, against which a spacer washer 37 arranged on the valve pin 32 bears. Arranged in a manner bearing against the spacer washer 37 are a valve plate spring 38 and a valve disc 39.

The balance valve 31 is configured as an automatic valve. It can be configured as a one-way valve. It is in particular configured such that it allows a flow from the balance chamber 6 through the second balance duct 26 into the second working chamber part 19. In other words, the balance valve 31 is configured such that it opens when the piston 13 moves in an extension direction 40 parallel to the direction of the longitudinal axis 7.

In the exemplary embodiment illustrated in FIGS. 1 to 4, the balance valve 31 is configured such that it allows a bidirectional flow through the second balance duct 26. It is thus configured as a two-way valve. The balance valve 31 can in particular have impressions which, independently of the position of the valve disc 39, enable a bidirectional through-flow between the second working chamber part 19 and the balance chamber 6.

In general, provision is made for the balance valve 31 to form an overload protection element which ensures that the second balance duct 26 is open if a predetermined limit force on the piston rod 12 in the direction of the longitudinal axis 7 is exceeded. The activation characteristic of this overload protector can be achieved easily by a suitable choice and dimensioning of the valve coil spring 33 and of the valve plate spring 38.

An alternative structural design of the balance valve 31 is conceivable. For further details of the balance valve 31, reference is made to DE 10 2005 023 756 A1, in particular paragraph [0022].

The piston rod 12 is configured in a multipart, in particular two-part manner. It comprises an outer piston rod sleeve 48, formed in a tubular manner, and a piston rod core 49.

The piston rod sleeve 48 can be connected to the first fastening element 14. The first fastening element 14 has a transition fit 66 which is arranged concentrically with the longitudinal axis 7 and by way of which the first fastening element is plugged onto an outer side of the piston rod 12, in particular of the piston rod sleeve 48. The first fastening element 14 is connected to the piston rod 12 by a weld 67.

The first fastening element 14 can alternatively have an internal thread, by means of which the first fastening element 14 is screwed onto a matching external thread on the piston rod sleeve 48.

The piston rod core 49 is sealed off from the piston rod sleeve 48 by means of a sealing ring 61. The sealing ring 61 is arranged in an annular groove 68 in the piston rod core 49. In the region of the sealing ring 61, the piston rod sleeve 48 is formed in a reinforced manner towards the inside, that is to say radially with respect to the longitudinal axis 7. Here, it has a reinforcement 62. Apart from the groove 68, the piston rod core 49 is formed in a fully cylindrical manner in the region of the reinforcement 62. In the region of the reinforcement 62, the piston rod core 49 bears against the piston rod sleeve 48 in a form-fitting manner. As a result, it is mounted in the piston rod sleeve 48 without play in the radial direction.

The piston rod core 49 has a circular cross section in particular in the region of the reinforcement 62. It is thus formed in a fully cylindrical manner at least in this region.

In an end region 69 adjoining this region counter to the extension direction 40, the piston rod core 49 has a recess 70. The recess 70 is formed in the form of a circle segment in the direction perpendicular to the longitudinal axis 7. It has a centre angle. The centre angle is at least 15°, in particular at least 30°, in particular at least 45°, in particular at least 60°, in particular at least 90°. It can in particular also be 120°. At most 270°, in particular at most 180° are provided as the upper limit for the centre angle. In principle, a configuration of the recess 70 in the form of a sector of a circle is also possible. The recess can also be configured as a bore in the piston rod core 49.

The piston rod core 49 is an adjusting element which is embodied in the form of a cover. The adjusting element 49, an adjusting actuator 89 and a force transmission device 87 form an adjusting unit.

The adjusting unit has a signal link via the adjusting actuator 89 to a control unit 92 illustrated purely schematically in FIG. 1. The control unit 92 can also be embodied in a manner integrated in the adjusting actuator 89.

The recess 70 is part of a through-flow duct 71 which forms a through-flow connection between the working chamber parts 17, 19. In addition to the recess 70, the through-flow duct 71 comprises a plurality of bores 72 in the piston rod sleeve 48. In other words, the bores 72 together with the recess 70 form the through-flow duct 71. The through-flow duct 71 is thus arranged in the piston rod 12. Depending on the rotational position of the piston rod core 49 with respect to the longitudinal axis 7, how many or which of the bores 72 are opened up by the recess 70 or covered is defined. This results in an effective flow cross-sectional area of the through-flow duct 71.

At least one bore 72 is provided in the piston rod sleeve 48. In the exemplary embodiment illustrated in FIGS. 1 to 4, the piston rod sleeve 48 has two bores 72. It can also have three, four, five or more bores 72. The bores 72 are each arranged in a manner offset with respect to one another in the circumferential direction. The bores 72 are all the same size. However, bores 72 with different sizes are likewise conceivable.

As an alternative to a plurality of discrete bores 72, the piston rod sleeve 48 can also have a through-flow opening configured in an elongate manner. The through-flow opening extends preferably in the circumferential direction. It covers an angular range which is at most as large as the centre angle of the recess 70 in the piston rod core 49.

By means of the end region 69 of the piston rod core 49, the bores 72 are selectively closable. The end region 69 of the piston rod core 49 thus forms an adjusting element, by means of which the effective flow cross section of the through-flow duct 71 is adjustable. The adjusting element for adjusting the effective flow cross section of the through-flow duct 71 is thus arranged in the interior of the piston rod 12, in particular in the interior of the piston rod sleeve 48.

By means of the adjusting element, the through-flow duct 71 is in particular closable in order to interrupt the through-flow connection between the working chamber parts 17, 19. As a result, the damper 1 is blockable.

A plurality of discrete bores 72 allow a plurality of different discrete damping settings of the damper 1. The damper 1 can thus have a stepped damping characteristic. Through an advantageous arrangement of the bores 72, it is possible to allow a continuously adjustable damping behaviour of the damper 1, in that for example the bores 72 are arranged in an at least partially overlapping manner in an activating direction of the adjusting element 102. The adjusting direction of the adjusting element 102 is oriented axially and/or tangentially to the longitudinal axis 7. Likewise, an elongate opening in the piston rod sleeve 48 allows a continuously adjustable damping behaviour of the damper 1.

The piston rod core 49 is displaceable, in particular rotatable, with respect to the piston rod sleeve 48. For this purpose, it is connected to an adjusting lever 63. The adjusting lever 63 is connected to the piston rod core 49 in the region of the first fastening element 14. For this purpose, the first fastening element 14 has a cutout 64. The adjusting lever 63 is arranged in particular in a bore 65 in the piston rod core 49. The bore 65 extends perpendicularly to the longitudinal axis 7. The adjusting lever 63 is pressed into the bore 65. Alternatively, provision can be made to provide the adjusting lever 63 with an external thread and the bore 65 with a matching internal thread. The adjusting lever 63 can in particular be screwed into the piston rod core 49. This allows particularly easy assembly. Furthermore, this allows easy exchangeability of the adjusting lever 63 and of the piston rod core 49. It is also conceivable to configure the piston rod core 49 to be displaceable with respect to the piston rod sleeve 48.

The adjusting lever 63 can bear against the piston rod sleeve 48 in the direction of the longitudinal axis 7. It thus fixes the piston rod core 49 so that it is prevented from being displaced unintentionally counter to the extension direction 40 relative to the piston rod sleeve 48. Fixing of the piston rod core 49 in the piston rod sleeve 48 so that it is prevented from being displaced with regard to the longitudinal axis 7 can also be achieved with alternative, separate fixing means.

A pivot lever 82 is articulated to the mounting plate 81 so as to be pivotable about a pivot 83. The pivot lever 82 is embodied substantially in an L-shaped manner with a first lever arm 84 and a second lever arm 85. The lever arms 84, 85 intersect at the apex of the pivot lever 82. The pivot 83 extends through the apex of the pivot lever 82.

A connecting element 86, which acts on the adjusting lever 63, is articulated to a free end of the first pivot arm 84, which is arranged opposite the pivot 83.

The pivotability of the pivot lever 82 about the pivot 83 is embodied in particular in a spring-mounted manner, wherein the illustration according to FIG. 1 shows the pivot lever 82 in a starting arrangement. Upon activation of a pulling element in the form of a Bowden cable 87, the internal wire of the Bowden cable is extended out of the outer sheath and thus the pivot lever 82, in particular the second lever arm 85, is rotated anticlockwise with respect to the pivot 83. The first lever arm 84 is correspondingly rotated anticlockwise about the pivot 83. Via the connecting element 86, the adjusting lever 63 is rotated and thus adjustment of the damping action in the manner outlined below is allowed.

A pulling element in the form of a Bowden cable is articulated to the free end of the second lever arm 85, which is arranged opposite the apex of the pivot lever 82. The sheath of the pulling element is fixed in a holder 88, provided for this purpose, on the mounting plate 81. At an opposite end, away from the mounting plate 81, the pulling element is articulated to an adjusting actuator 89. According to the exemplary embodiment shown, the adjusting actuator 89 is embodied by a motor/gear mechanism unit 90, to the drive shaft of which an eccentric element 91 is articulated.

The pulling element is a force transmission device.

An essential advantage of this exemplary embodiment is that the damper and in particular the adjustment of the damping action can be ensured in an uncomplicated manner, in particular by means of known components. The damper can in particular be retrofitted in an uncomplicated manner. The Bowden cable 87 can in particular be arranged substantially freely, taking the bending radii to be complied with into consideration. In particular, it is conceivable to arrange the Bowden cable in a space-saving manner in the available installation space. This results in additional degrees of freedom in the arrangement of the Bowden cable. The Bowden cable is part of a force transmission device which serves to transmit the actuating force provided by the adjusting actuator 89. The adjusting actuator 89 is arranged outside and at a distance from the housing 4 of the damper 1.

At a first piston rod end 50 arranged in the inner housing 8, the piston rod sleeve 48 has a reduced outside diameter, thereby forming a piston rod stop 51. Starting from the piston rod stop 51, a first spacer washer 52, a first closure element 53, in particular in the form of a plate spring, a piston disc 54, a second closure element 55, in particular in the form of a plate spring, a second spacer washer 56 and a securing nut 57 are arranged on the piston rod sleeve 48 in the region of the first piston rod end 50. The securing nut 57 is screwed onto a piston rod thread and secures the piston 13 on the piston rod 12. The piston 13 is formed by the first closure element 53, the piston disc 54, the second closure element 55 and a piston seal 58. The piston seal 58 is configured in an annular manner and arranged in an annular groove 59 in the piston disc 54. The piston seal 58 thus seals the piston disc 54 off from the inner housing 8.

Provided in the piston disc 54 are a plurality of through-flow ducts 60. The through-flow ducts 60 form a through-flow connection between the first working chamber part 17 and the second working chamber part 19. The closure elements 53, 55 each interact with at least one of the through-flow ducts 60. They can also interact with a plurality of the through-flow ducts 60. They can act in particular as valve elements and influence the efficient flow cross section of the through-flow ducts 60, depending on a direction and/or speed of movement of the piston 13 with respect to the extension direction 40. They can in particular be configured such that only a unidirectional flow through the through-flow ducts 60 is possible. In this case, the closure elements 53, 55 form a one-way valve. The closure elements 53, 55 can in particular be configured such that they open when a particular limit force is exceeded. In this case, they form an overload protector.

An alternative embodiment of the piston 13 is conceivable. In this regard, for further details with regard to the through-flow duct 60 and the closure elements 53, 55, reference is made to the description of DE 10 2005 023 756 A1, in particular paragraphs [0023] et seq. It is in particular also possible to configure the piston 13 in a sealed manner, that is to say without through-flow ducts 60. In this case, the working chamber parts 17, 19 are separated in a fluid-tight manner by the piston 13. In this case, the through-flow duct 71 in the piston rod 12 forms the only direct through-flow connection between the working chamber parts 17, 19.

In the following text, the adjustability of the effective flow cross section of the through-flow duct 71 by means of the end region 69, forming the adjusting element, of the piston rod core 49 is described. The adjusting element is able to be activated by way of a movement with respect to the longitudinal axis 7, in particular by rotation. It is likewise conceivable to provide an adjusting element that is able to be activated by displacement with respect to the longitudinal axis 7. The adjusting element is in particular able to be activated by means of the adjusting lever 63. In a first adjusting position, the end region 69 of the piston rod core 49 does not cover either of the bores 72. Both bores 72 thus contribute towards the effective flow cross section of the through-flow duct 71. In other words, the through-flow duct 71 has its greatest possible effective flow cross section. The damping of a movement of the piston rod 12 is at a minimum, that is to say the resistance to such a movement in or counter to the extension direction 40 is as low as possible. In this adjusting position, the damper 1 exhibits its softest possible damping.

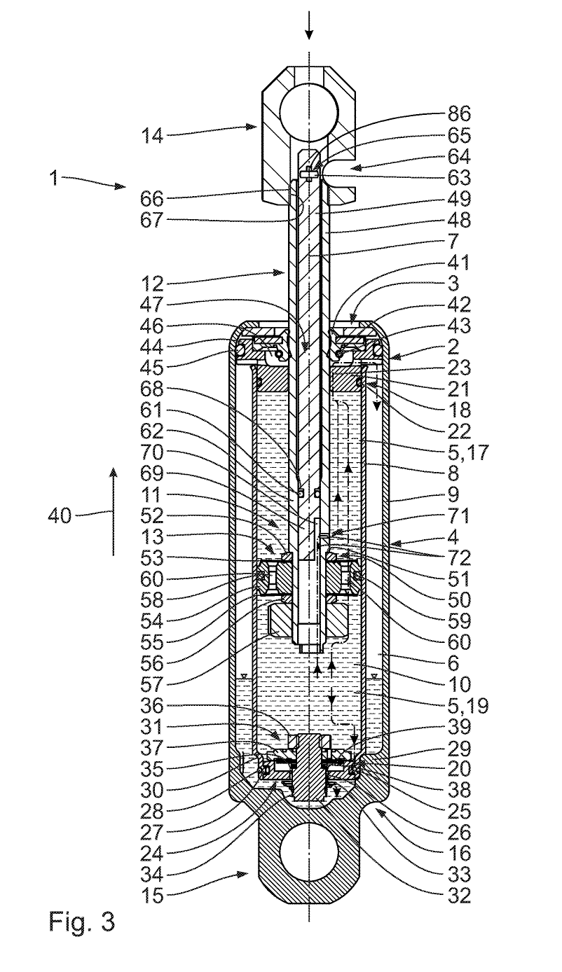

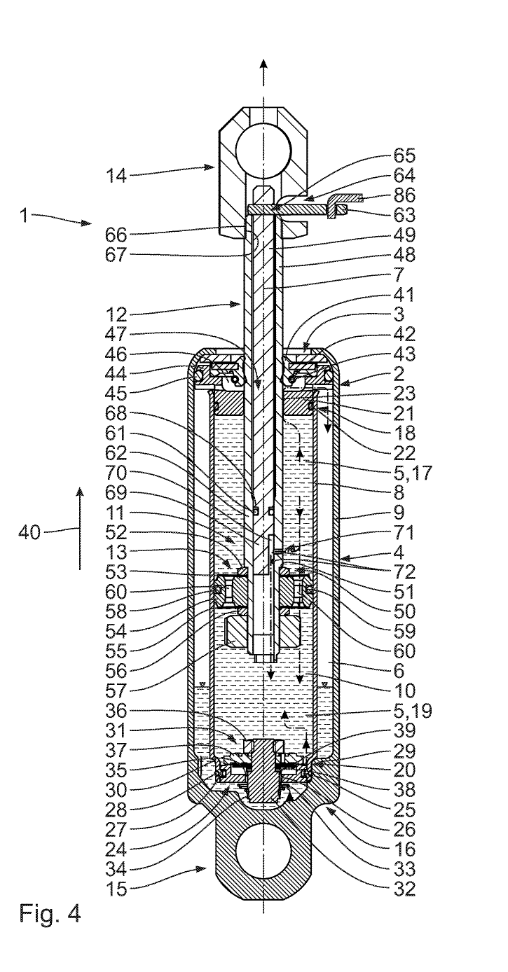

In a further adjusting position, the end region 69 of the piston rod core 49 covers one of the bores 72, while the other remains open. As a result, the effective flow cross section is reduced by half compared to the adjusting position illustrated in FIGS. 3 and 4. The damping of the damper 1 is thus harder.

In a further adjusting position, the end region 69 of the piston rod core 49 covers both, that is to say all of the bores 72. The through-flow duct 71 is closed in this position. Its effective flow cross section is zero. The through-flow connection between the working chamber parts 17, 19 through this through-flow duct 71 is interrupted. A through-flow connection for the damping fluid 10 between the working chamber parts 17, 19 is provided at most via the balance ducts 23, 26 and the balance chamber 6. The damping of a movement of the piston rod 12 is at a maximum in this adjusting position, that is to say that the resistance to a movement of the piston rod 12 in or counter to the extension direction 40 is as high as possible. In this adjusting position, the damper 1 exhibits its hardest possible damping. It can in particular be blocked.

With regard to the embodiment of the piston rod 12 with the piston rod core 49 and the piston rod sleeve 48 and to the function thereof for adjusting the adjusting unit, reference is made to DE 10 2010 029 180 A1. What is essential is that the adjusting lever 63, by means of which the adjusting element 49 is rotated about the longitudinal axis 7 in the piston rod 12, is able to be activated in an automated and in particular controlled manner via the force transmission device 87 and the adjusting actuator 89.

The function of the damper 1 is described in the following text. In the adjusting position, illustrated in FIGS. 3 and 4, of the adjusting element, the through-flow duct 71 in the piston rod 12 is opened to a maximum. In the event of a movement of the piston 13 counter to the extension direction 40, the damping fluid 10 can thus flow from the second working chamber part 19, through the through-flow duct 71 in the piston rod 12, and into the first working chamber part 17. Furthermore, the damping fluid 10 displaced out of the working chamber 5 by the additional volume of the piston rod 12 can flow into the balance chamber 6 through the first balance duct 23.

Provision is made for the second balance duct 26 to be as closed as much as possible in the event of small forces, directed counter to the extension direction 40, on the piston rod 12, in particular at low speeds of the piston 13 counter to the extension direction 40. In a balance valve 31 which allows bidirectional flow through the second balance duct 26, the balance valve 31 is not completely closed. On account of the impressions, a bidirectional flow through the second balance duct 26 is always possible. However, in principle, it is also possible for the balance valve 31 to be configured as a one-way valve which is in a blocking position in the event of small forces, directed counter to the extension direction 40, on the piston rod 12. The response behaviour of the balance valve 31 is determined by a suitable choice and setting of the valve coil spring 33 and of the valve plate spring 38.

In a corresponding manner, the through-flow duct 60 in the piston 13 can be closed by the first and/or second closure element 53, 55 at low speeds of the piston 13.

In the event of a movement of the piston 13 in the extension direction 40, the damping fluid 10 can flow from the first working chamber part 17, through the through-flow duct 71 in the piston rod 12, and into the second working chamber part 19. Furthermore, the balance valve 31 opens and allows damping fluid 10 to flow out of the balance chamber 6, through the second balance duct 26, and into the second working chamber 19. This ensures that the working chamber 5 is always completely filled with damping fluid 10, apart from the volume displaced by the piston unit 11.

The balance valve 31 in the second termination element 24 and/or the closure elements 53, 55 in the piston 13 can be configured such that, in the event of a movement of the piston rod 12 in the extension direction 40, damping fluid 10 flows through the second balance duct 26 in the second termination element 24 and/or the through-flow duct 60 in the piston 13 only in the event of a high extension speed of the piston rod 12 or a large force on the latter in the extension direction 40.

The through-flow duct 60 in the piston 13 and/or the balance valve 31 in the second termination element 24 thus act as an overload protector which is triggered at high speeds and/or large forces on the piston rod 12 and thus prevents the damper 1 from being damaged. Of course, the damping behaviour of the damper 1 can be influenced as desired by a suitable choice of the closure elements 53, 55 of the through-flow duct 60 and/or of the valve elements 33, 38 of the balance valve 31.

As a result of the piston rod core 49 being rotated about the longitudinal axis 7 by means of the adjusting lever 63, the bores 72 of the through-flow duct 71 in the piston rod 12 can be closed by the end region 69 of the piston rod core 49. As a result, the effective flow cross section of the through-flow duct 71 in the piston rod 12 is reduced, in particular closed, in particular completely closed. It is then no longer possible for damping fluid 10 to flow out of the first working chamber part 17, through the through-flow duct 71, and into the second working chamber part 19 or vice versa.

Inasmuch as the balance valve 31 prevents damping fluid 10 from flowing out of the second working chamber part 19 and into the balance chamber 6, the piston rod 12 is blocked so that it cannot be displaced counter to the extension direction 40 in this position of the adjusting element formed by the piston rod core 49, in particular the end region 69 thereof, on account of the completely closed volume of the second working chamber part 19.

However, if the force on the piston rod 12 exceeds a predetermined limit force in the direction counter to the extension direction 40, the overload protector is activated and the through-flow duct 60 in the piston 13 and/or the second balance duct 26 in the second termination element 24 is opened.

Since the balance valve 31 in the second termination element 24 opens in the event of a movement of the piston 13 in the extension direction 40, in order to allow damping fluid 10 to flow out of the balance chamber 6 and into the second working chamber part 19, and the first balance duct 23 in the first termination element 21 is closed, the damper 1 is not completely blocked so as to prevent the piston rod 12 from moving in the extension direction 40, even in the case of a closed through-flow duct 71 in the piston rod 12. However, it exhibits maximum hard damping, since the damping fluid 10 cannot flow from the first working chamber part 17 into the second working chamber part 19 through the through-flow duct 71 in the piston rod 12, but rather flows from the first working chamber part 17 into the balance chamber 6 and from the balance chamber 6 through the second balance duct 26 into the second working chamber part 19. Thus, in this case, the damping characteristic is determined by the balance ducts 23, 26 and, in particular, by the balance valve 31.

In an alternative embodiment, provision can be made for the closure elements 53, 55 to be configured such that the through-flow ducts 60 in the piston 13 open or close depending on the speed of the movement of the piston rod 12 in the extension direction 40. As a result, a speed-dependent damping characteristic can be achieved. For details in this regard, reference is made to DE 10 2005 023 756 A1, paragraphs [0028] et seq.

In an alternative embodiment of the second termination element 24 according to the embodiment shown in FIGS. 3 and 4, the second termination element 24 can be axially supported at the end against the inner housing 8 by way of an abutment shoulder 100 and be radially supported against the inner cylindrical lateral surface of the inner housing 8 by way of a plug-in collar 101. The plug-in collar 101 is pretensioned radially with respect to the longitudinal axis 7 by means of a radial spring element 102, wherein the pretensioning is applied axially by means of a clamping nut 103 on a clamping bolt 104. In the region in which the plug-in collar 101 bears against the inner cylindrical lateral surface of the inner housing 8, the inner housing 8 is pressed radially outwards against an inner side of the outer housing 9 and as a result held.

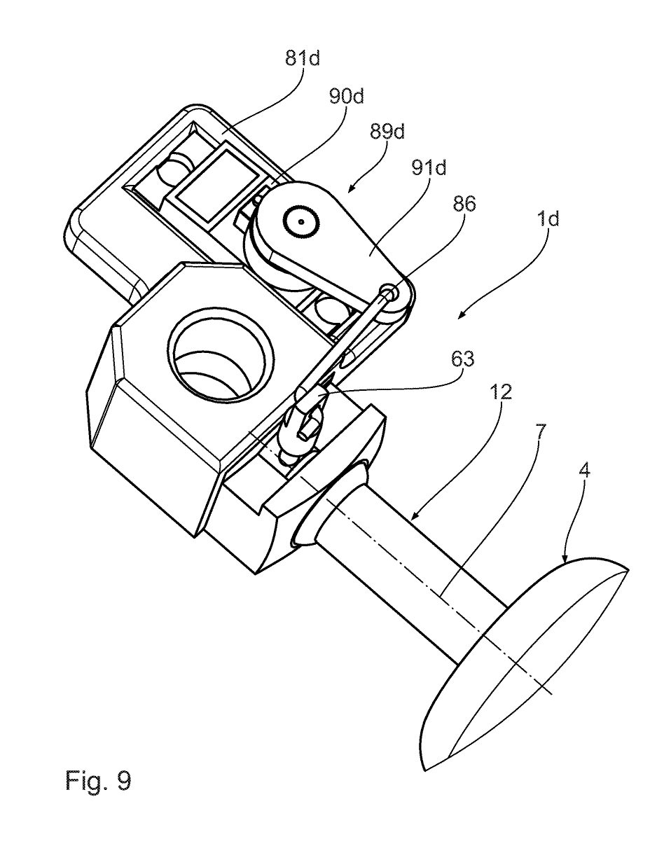

In a further embodiment that is not illustrated, an additional switching element can be provided, which closes at least one of the balance ducts 23, 26 or both balance ducts 23, 26 depending on the activation direction of the damper 1. Such a switching element is known from DE 10 2010 029 180 A1, to which reference is hereby made, in particular to FIG. 9 of DE 10 2010 029 180 A1, and corresponding US 2011/0284333 A1, the entire contents of which are hereby incorporated by reference.

In the case of an interruption to the power supply, the position detection unit 107 ensures that the position detection is reset by means of a reference move. To this end, in particular a reference mark, which can be embodied for example as a stop element, is used. This ensures that, following an unforeseen interruption to the movement of the adjusting element, the position thereof can be established and fixed clearly and in an uncomplicated manner.

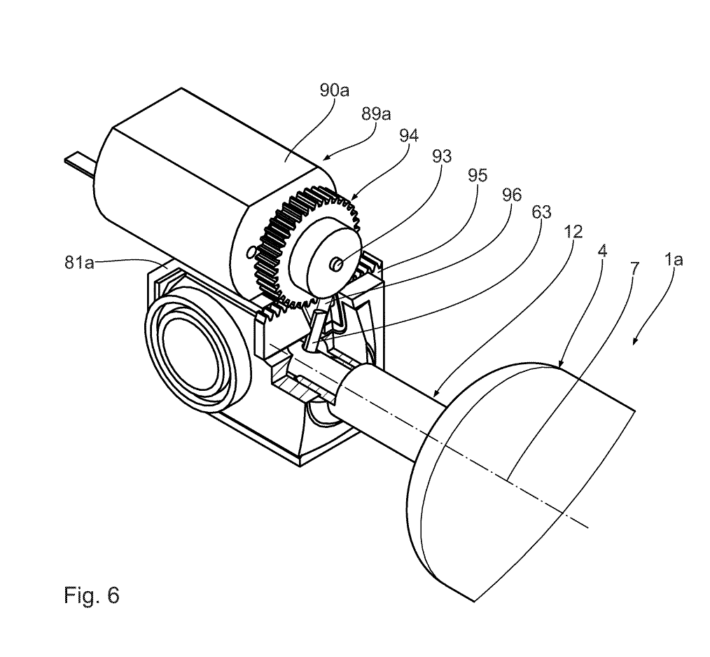

A further exemplary embodiment of the invention is described in the following text with reference to FIG. 6. Identical parts are provided with the same reference signs as in the first exemplary embodiment, to the description of which reference is hereby made. Structurally different, but functionally identical parts are provided with the same reference signs followed by an a.

According to the exemplary embodiment shown, the adjusting actuator 89a is embodied with a motor/gear mechanism unit 90a as rotary drive. A gear wheel 94 is arranged coaxially, as part of the force transmission device, on an output shaft 93 of the electric motor 90a. The gear wheel 94 has a toothing which corresponds to a counterpart toothing of the adjusting element in the form of a rack 95. The rack 95 has, on an underside located away from the counterpart toothing, a substantially V-shaped recess 96 in which the adjusting lever 63 is arranged.

The force transmission device acts directly on the adjusting lever 63. The force transmission device, in particular the rack 95 with the recess 96, acts directly on the adjusting lever 63.

In the exemplary embodiment according to FIG. 6, the adjusting actuator 89a is fastened directly to the mounting plate 81a.

In order to adjust the damping action of the damper 1a, the adjusting actuator 89a is activated. Depending on the direction of rotation of the electric motor 90a, the gear wheel is rotated clockwise or anticlockwise and this rotary movement is transmitted directly to the rack 95. With respect to the longitudinal axis 7, the rack 95 is moved perpendicularly thereto. As a result of the transverse movement of the rack 95, the adjusting lever 63 arranged in the recess 96 is carried along and thus the adjustment of the damping action is brought about in the above-described manner.

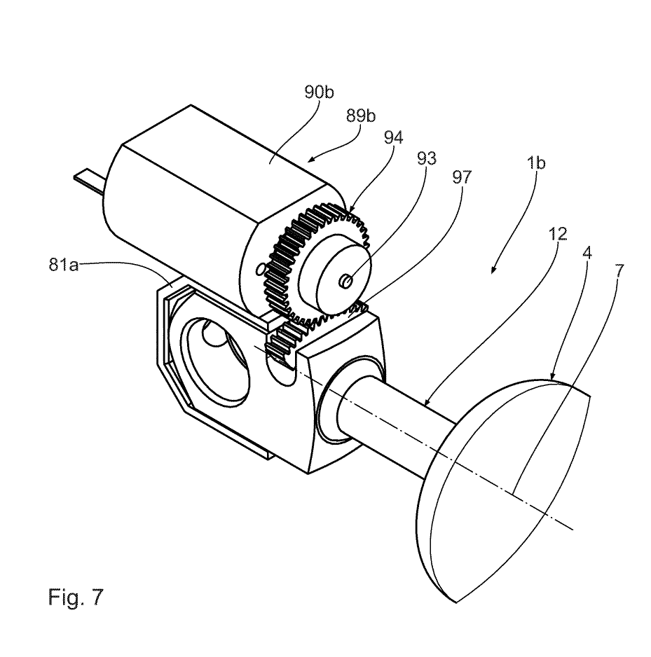

A further exemplary embodiment of the invention is described in the following text with reference to FIG. 7. Identical parts are provided with the same reference signs as in the first exemplary embodiment, to the description of which reference is hereby made. Structurally different, but functionally identical parts are provided with the same reference signs followed by a b.

The essential difference with respect to the previous exemplary embodiment is that, in the case of the damper 1b, the counterpart toothing of the force transmission device is embodied on a counterpart gear wheel 97. The counterpart gear wheel 97 is embodied in particular in the form of a gear wheel segment with an opening angle range of about 90° with respect to the longitudinal axis 7. Such an opening angle range is sufficient to allow the necessary rotation of the piston rod core 49 in the piston rod sleeve 48. The embodiment of the counterpart gear wheel 97 as a gear wheel segment is space-saving. The counterpart gear wheel 97 is connected to the piston rod core 49 for conjoint rotation. In particular, the axis of rotation of the counterpart gear wheel 97 is identical to the longitudinal axis 7 of the piston rod 12.

The coupling of the counterpart toothing to the adjusting element is embodied in a particularly robust manner as a result. A separate adjusting lever can be dispensed with.

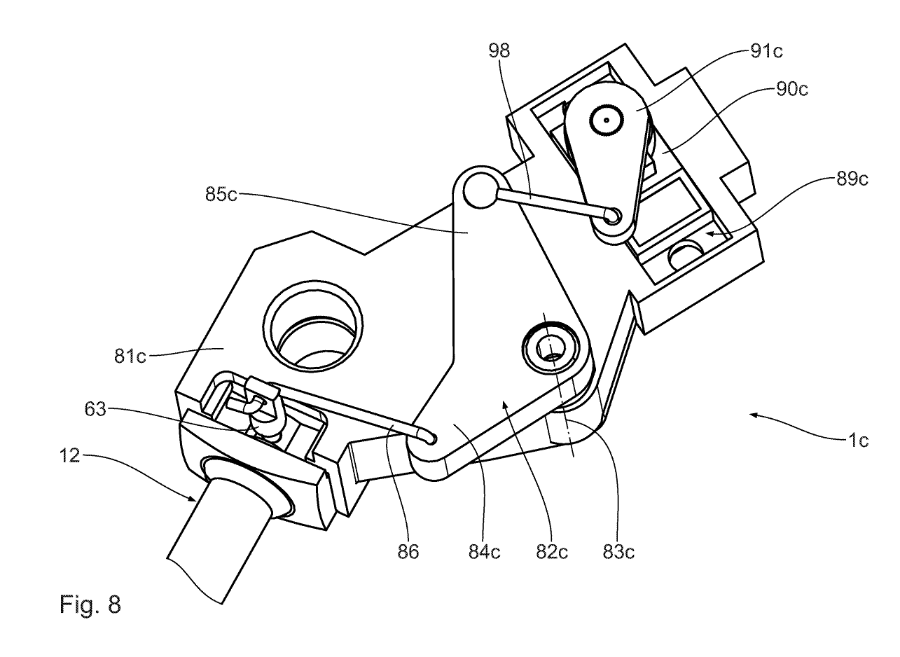

A further exemplary embodiment of the invention is described in the following text with reference to FIG. 8. Identical parts are provided with the same reference signs as in the first exemplary embodiments, to the description of which reference is hereby made. Structurally different, but functionally identical parts are provided with the same reference signs followed by a c.

The embodiment corresponds substantially to the first embodiment according to FIG. 1, wherein, instead of the Bowden cable, a second connecting element 98 is articulated in a pivotable manner to the second lever arm 85c of the pivot lever 82c. By way of a free end away from the pivot lever 82c, the second connecting element 98 is articulated directly to an eccentric element 91c on a motor/gear mechanism unit 90c.

According to the exemplary embodiment shown, it is possible to attach the adjusting actuator 89c directly to the mounting plate 81c. The installation space required is reduced. The embodiment shown is able to be retrofitted in an uncomplicated and direct manner in the case of the damper 1c, in that the Bowden cable is replaced by the second connecting element 98 and the adjusting actuator 89c.

A further exemplary embodiment of the invention is described in the following text with reference to FIG. 9. Identical parts are provided with the same reference signs as in the first exemplary embodiments, to the description of which reference is hereby made. Structurally different, but functionally identical parts are provided with the same reference signs followed by a d.

The exemplary embodiment shown corresponds substantially to the exemplary embodiment according to FIG. 8, wherein the eccentric lever 91d acts directly on the adjusting lever 63 via the connecting element 86. The pivot lever can thus be dispensed with. The number of components and in particular the installation space required for the damper 1d are reduced.

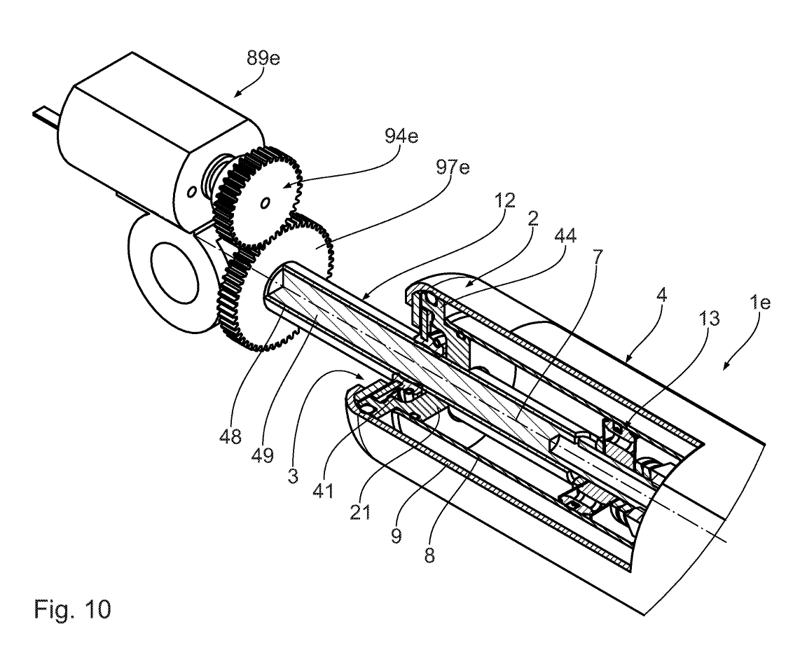

A further exemplary embodiment of the invention is described in the following text with reference to FIG. 10. Identical parts are provided with the same reference signs as in the first exemplary embodiments, to the description of which reference is hereby made. Structurally different, but functionally identical parts are provided with the same reference signs followed by an e.

This embodiment corresponds substantially to the embodiment with a gear wheel and counterpart gear wheel element according to FIG. 7. The essential difference according to the exemplary embodiment shown is that the counterpart gear wheel 97e is not directly coupled to the piston rod core 49, i.e. to the adjusting element, but to the piston rod sleeve 48 of the piston rod 12. The actuating force of the adjusting actuator 89e brings about an immediate adjustment of the piston rod 12 with respect to the longitudinal axis 7 via the gear wheel 94e and the counterpart gear wheel 97e. In the damper 1e, the piston rod core 49 is embodied in a fixed manner, wherein the piston rod sleeve 48 can rotate about the piston rod core 49 with respect to the longitudinal axis 7. Additional force transmission elements can be dispensed with, since the actuating movement is transmitted directly by the adjusting actuator 89e.

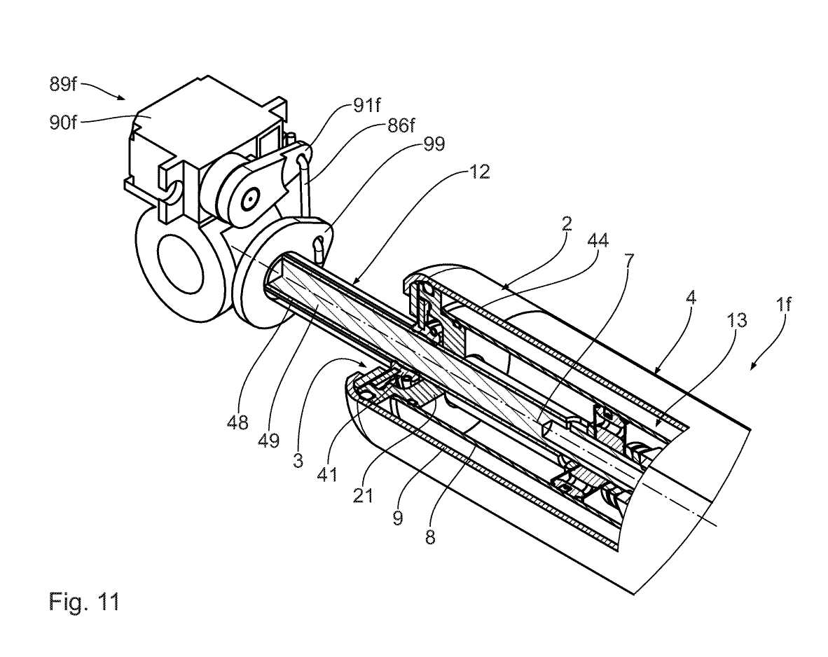

A further exemplary embodiment of the invention is described in the following text with reference to FIG. 11. Identical parts are provided with the same reference signs as in the first exemplary embodiments, to the description of which reference is hereby made. Structurally different, but functionally identical parts are provided with the same reference signs followed by an f.

The damper 1f according to FIG. 11 corresponds substantially to the one according to FIG. 10, wherein the adjusting actuator 89f is embodied as a motor/gear mechanism unit 90f and an eccentric lever 91f articulated thereto. The eccentric lever 91f is connected to an eccentric disc 99 by means of the connecting element 86f. The connecting element 86f is articulated eccentrically to the eccentric disc 99 with respect to the longitudinal axis 7. A movement of the eccentric element 91f brings about eccentric force transmission to the eccentric disc 99 via the connecting element 86f. The eccentric disc 99 is connected to the piston rod 12 for conjoint rotation. As a result of an actuation of the adjusting actuator 89f, the piston rod 12 is rotated with respect to the longitudinal axis 7, as in the previous exemplary embodiment.

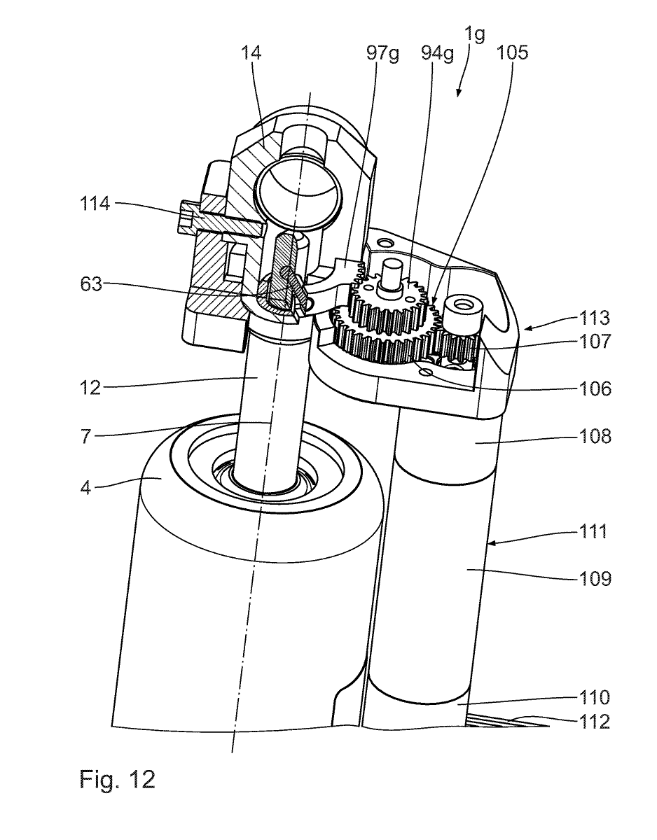

A further exemplary embodiment of the invention is described in the following text with reference to FIG. 12. Identical parts are provided with the same reference signs as in the first exemplary embodiments, to the description of which reference is hereby made. Structurally different, but functionally identical parts are provided with the same reference signs followed by a g.

In the damper 1g according to FIG. 12, the adjusting lever 63 is received in an opening in the counterpart gear wheel 97g. The counterpart gear wheel 97g cooperates with the gear wheel 94g in order to allow the adjusting lever 63 to rotate with respect to the longitudinal axis 7 of the damper 1g.

The gear wheel 94g transmits the rotary movement of a coaxially arranged drive gear wheel 106 to a reduction gear stage 105. The reduction gear stage 105 comprises a pinion gear 107 which is arranged on an output shaft of a gear mechanism 108.

The gear mechanism 108 is arranged coaxially with a motor, in particular an electric motor 109, on which an encoder 110 is provided. The encoder 110 is arranged at a first end of the electric motor 109, which is arranged opposite the second end, at which the gear mechanism 108 is arranged. The gear mechanism 108, the motor 109 and the encoder 110 can be arranged in a space-saving manner in a cylindrical housing 111 along the longitudinal cylinder axis, which is oriented in particular parallel to the longitudinal axis 7 of the damper 1g.

Signal transmission cables 112 and/or power cables for signal transmission or power supply are connected to the encoder 110. The motor 109, the gear mechanism 108 and the encoder 110 form a common motor/gear mechanism unit which is fastened releasably, by means of a plate-like fastening unit 113, to the first fastening element 14 by means of a screw connection 114.

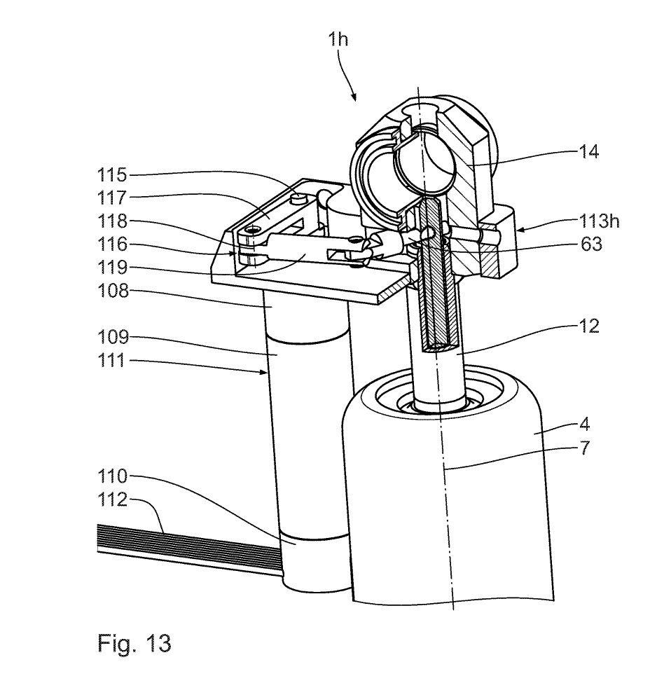

A further exemplary embodiment of the invention is described in the following text with reference to FIG. 13. Identical parts are provided with the same reference signs as in the first exemplary embodiments, to the description of which reference is hereby made. Structurally different, but functionally identical parts are provided with the same reference signs followed by an h.

The damper 1h has a motor/gear mechanism unit 108, 109, 110 which is accommodated in a housing 111. A multiple joint hinge 116 is articulated to the output shaft 115 of the gear mechanism 108. The multiple joint hinge 116 comprises a first hinge lever 117, which is articulated pivotably by way of its first end to the output shaft 115. At an opposite end, the first hinge lever 117 is connected to a second hinge lever 119 of the multiple joint hinge 116 so as to be pivotable about an internal hinge axis 118.

At a second end, located opposite the internal hinge axis 118, the second hinge lever 119 is connected to the adjusting lever 63 in an articulated manner. As a result of the activation of the motor/gear mechanism unit, the multiple joint hinge 116 is pivoted directly via the output shaft 115, from which a pivoting movement for the adjusting lever 63 can be derived directly.

In the exemplary embodiment according to FIG. 13, the fastening unit 113h is able to be arranged in a releasable manner on the first fastening element 14 by means of a screw (not illustrated) of a screw fastener.

What is claimed is:

1. A damper comprising
a. a housing (4) having a working chamber (5);
b. damping fluid (10) located in the working chamber (5);
c. a piston unit (11) arranged in the working chamber (5), having
i. a piston rod (12) having a longitudinal axis (7),
ii. a piston (13) fastened to the piston rod (12), said piston (13) subdividing the working chamber (5) into a first working chamber part (17) and into a second working chamber part (19),
iii. a through-flow duct (71) connecting the first working chamber part (17) and the second working chamber part (19);
d. an adjusting unit for adjusting the damping force of the damper (1; 1a; 1b; 1c; 1d; 1e; 1f), having
i. an adjusting element (49) for adjusting the effective flow cross-sectional area of the through-flow duct (71),
ii. an adjusting actuator (89; 89a; 89c; 89f) for automatically adjusting an arrangement of the adjusting element (49) and of the piston rod (12),
iii. a force transmission device (87) for transmitting an actuating force provided by the adjusting actuator (89; 89a; 89c; 89f),
wherein the adjusting actuator (89; 89a; 89c; 89f) is arranged outside the housing (4).

2. A damper according to claim 1, comprising a control unit (92) which has a signal link to the adjusting unit, for the controlled adjustment of the effective flow cross-sectional area of the through-flow duct (71).

3. A damper according to claim 1, wherein the adjusting element (49) and the piston rod (12) are rotatable about the longitudinal axis (7) relative to one another.

4. A damper according to claim 1, wherein the adjusting element (49) is rotatable about the longitudinal axis (7).

5. A damper according to claim 4, wherein the adjusting element (49) is drivable in rotation about the longitudinal axis (7).

6. A damper according to claim 1, wherein the piston rod (12) is rotatable about the longitudinal axis (7).

7. A damper according to claim 6, wherein the piston rod (12) is drivable in rotation about the longitudinal axis (7).

8. A damper according to claim 1, wherein the adjusting element (49) has an adjusting lever (63) which is oriented transversely with respect to the longitudinal axis (7).

9. A damper according to claim 8, wherein the adjusting lever (63) is oriented radially with respect to the longitudinal axis (7).

10. A damper according to claim 8, wherein the force transmission device (87) is articulated directly to the adjusting lever (63).

11. A damper according to claim 8, wherein the force transmission device (87) has a pivot lever (82; 82c) that is pivotable about a pivot (83), said pivot lever (82; 82c) being connected at a first end to the adjusting actuator (89; 89a; 89c; 89f) and at a second end to the adjusting lever (63).

12. A damper according to claim 11, wherein the pivot (83) is fixed to the damper.

13. A damper according to claim 11, wherein the force transmission device (87) has a pulling element, which connects the pivot lever (82; 82c) to the adjusting actuator (89; 89a; 89c; 89f).

14. A damper according to claim 13, wherein the pulling element is a Bowden cable.

15. A damper according to claim 1, wherein the adjusting actuator (89; 89a; 89c; 89f) is embodied as a rotary drive.

16. A damper according to claim 15, wherein the adjusting actuator (89; 89a; 89c; 89f) is embodied as an electric motor.

17. A damper according to claim 1, wherein the force transmission device (87) has a toothing, which corresponds to a counterpart toothing on the adjusting element (49).

18. A damper according to claim 17, wherein the force transmission device (87) has a gear wheel.

19. A damper according to claim 18, wherein the gear wheel is arranged directly on the output shaft (93) of the adjusting actuator (89; 89a; 89c; 89f).

20. A damper according to claim 17, wherein the counterpart toothing is embodied on a rack (95) which is coupled to the adjusting element (49).

21. A damper according to claim 20, wherein the rack (95) is directly coupled to the adjusting element (49).

22. A damper according to claim 20, wherein the rack (95) is directly coupled to the adjusting lever (63).

23. A damper according to claim 17, wherein the counterpart toothing is embodied on a counterpart gear wheel (97; 97e), wherein the counterpart gear wheel (97; 97e) is connected to the piston rod (12) for conjoint rotation.

24. A damper according to claim 23, wherein the axis of rotation of the counterpart gear wheel on which the counterpart toothing is embodied is identical to the longitudinal axis (7) of the piston rod (12).
